(19) United States
(12) Patent Application Publication
(10) Pub. No.: US 2013/0341324 A1
(43) Pub. Date: Dec. 26, 2013

(54) Multi-Compartment Receptacle

(71) Applicants: Jeffrey W. Helfrich, Dallas, TX (US); Elizabeth C. Helfrich, Dallas, TX (US)

(72) Inventors: Jeffrey W. Helfrich, Dallas, TX (US); Elizabeth C. Helfrich, Dallas, TX (US)

(73) Assignee: ALTA VISTA CREATIVE, LLC, Dallas, TX (US)

(21) Appl. No.: 13/925,763

(22) Filed: Jun. 24, 2013

Related U.S. Application Data
(60) Provisional application No. 61/663,486, filed on Jun. 22, 2012.

(51) Int. Cl. B65F 1/14

(52) U.S. Cl. CPC B65F 1/14
USPC 220/23.83

(57) ABSTRACT

A container for use as a waste receptacle that is stackable and may be made using a single continuous material. The container may lock together with an identical container to form a multi-compartment receptacle. Additionally, the container is stackable within identical containers. The container is easily separable from the locked position with another container.

### CROSS REFERENCE TO RELATED APPLICATION

This application claims the benefit of priority of U.S. Provisional Application No. 61/663,486, entitle “Multi-Compartment Receptacle,” filed Jun. 22, 2012 which is hereby expressly incorporated by reference herein.

### BACKGROUND

As recycling programs become more commonplace, consumers increasingly need convenient, affordable ways to participate in recycling programs. As a first step, consumers need to be able to separate recyclable products from “regular” garbage in order for most waste management companies to process recyclables. Often, the most convenient time for a consumer to separate recyclables from non-recyclables is at the time of disposal.

One solution that exists is for the consumer to use two separate receptacles, one for recyclables, and one for non-recyclables. The problem with this solution is that the consumer has to have space for two containers, and often floor space is limited in bathrooms, offices and other rooms of the house. In addition, having two containers is often an eyesore and not stylish.

Another solution that exists is for the consumer to use one receptacle for non-recyclables and for the consumer to use a paper or plastic grocery bag hung over a chair, a drawer, a door handle, or other similar knob for recyclables. The problem with this solution is that it is an eyesore. Another problem is that the grocery bags may tear resulting in the recyclables spilled on the floor.

Another solution that exists is for the consumer to use a single container with multiple compartments where one compartment is for recyclables and one compartment is for non-recyclables. The problem with this solution is that a consumer cannot easily empty one compartment at a time because the consumer cannot easily (1) use two separate bags in each container because the bags will slip down into the container and (2) the consumer cannot merely tip over one container without tipping over the other container. The consumer has to cover up the recyclable compartment when he or she pours out the non-recyclable compartment and vice-versa when emptying out the non-recyclables compartment. Another problem with this solution is that more than one of these containers cannot be stacked together for shipping, storage, or display because the walls separating the compartments typically prevent one container from stacking instead another container.

Another solution that exists is for the consumer to use a single container with multiple compartments where the compartments join only at the open edges of the compartments as illustrated, for example, in U.S. Pat. No. 5,242,071. This configuration allows the containers to stack together, but it does not allow a convenient way for the consumer to empty only one of the compartments at a time.

Another solution that exists is for the consumer to use a single container that contains two separate smaller compartments inside of it—one smaller compartment for recyclables and one smaller compartment for non-recyclables. An example of such a solution is illustrated in U.S. Pat. Nos. 7,703,622 and 6,123,214. With this configuration, the consumer is able to lift out whichever compartment that he or she would like to empty. The problem with this solution is that it is costly to manufacture. Another problem with this solution is that, similar to the previous solution, more than one of these containers cannot be stacked together for shipping, storage, or display.

### SUMMARY

A waste receptacle includes two separate identical and congruent containers that lock together to form a multi-compartment receptacle. This multi-compartment receptacle solves many problems consumers currently face. For example, this waste receptacle can be manufactured with reduced manufacturing costs, is stackable for easy storage, shipment, or display, and yet is stylish when assembled.

Another benefit of this waste receptacle is that the multi-compartment receptacle is sturdy because when the two congruent containers lock together, the side of one container and the side of the other container are adjacent, and these adjacent sides provide additional support for the receptacle as a whole.

Another benefit of this waste receptacle is that the containers of the multi-compartment receptacle are easily separable, thus permitting the consumer to empty one container at a time. In addition, this waste receptacle permits the consumer to use separate bags in each container and to fold the bag top over the edge of each container to keep the bag from slipping into the container during use.

Another benefit to this waste receptacle is that the consumer may choose to lift the multi-compartment receptacle using two hands, each hand being disposed through a handle on either side of the multi-compartment receptacle, or the consumer may lift the multi-compartment receptacle using one hand through the handles in the middle of the multi-compartment receptacle.

Another benefit of this waste receptacle is that the compact design of the multi-compartment receptacle is stylish because the two congruent containers combined provide the illusion of a single waste receptacle, even though they are, in fact, two separate containers.

Another benefit of this waste receptacle is that each individual container may be manufactured as a different color. Consumers may pick and choose which color or color combination they prefer. Permitting consumers to design their own multi-compartment receptacle allows them to match the style of their choosing, including choosing the colors of their alma mater, for example.

Another benefit of this waste receptacle is that multiple containers may be stacked to conserve space when shipping, storing, or displaying the receptacle for example, on a store shelf.

Another benefit to this waste receptacle is that the user may easily remove a container from a stack of containers using the handles of the container.

In one embodiment, a container for use as a waste receptacle contains a first side wall and a second side wall cooperating with the first side wall to form an enclosed space having two opposite ends. The container also contains an end wall connected to the first side wall and to the second side wall and disposed on a first one of the opposite ends of the enclosed space to form a closed end. The first side wall and the second side wall form an open end on a second one of the opposite ends of the enclosed space, the first side wall and the second side wall being tapered such that a perimeter of the closed end is smaller than a perimeter of the open end, and the second side wall of the container being inversely symmetrical about a center line through the second side wall that extends from the open end to the closed end, and the first side wall meets the second side wall at the edges of the second wall which edges lie in a plane that also goes through the center line of the second wall.

In another embodiment, the container may also contain a lock mechanism connected to the second side wall.

In another embodiment, the lock mechanism may also contain a female lock member and a male lock member.

In another embodiment, the male lock member may also contain a protrusion and the female lock member may contain an indentation such that the protrusion is the size of the space created within the indentation.

In another embodiment, the male lock member and the female lock member may be annular.

In another embodiment, the male lock member and the female lock member may be oblong.

In another embodiment, the second side wall may have a first panel, a second panel, and a middle panel.

In another embodiment, the middle panel may be planar, wavy, formed with protrusions and indentations connected by acute angles, formed with protrusions and indentations connected by segments of perpendicular straight lines, or other type forms.

In another embodiment, the lock mechanism may contain a female lock member disposed in the first panel and a male lock member disposed in the second panel.

In another embodiment, the first side wall may contain a hole.

In another embodiment, the second side wall may contain a hole.

In another embodiment, the first side wall may contain a first hole and the second side wall may contain a second hole.

In another embodiment, a container for use as a waste receptacle contains a first side wall and a second side wall cooperating with the first side wall to form an enclosed space having two opposite ends. The container also contains an end wall connected to the first side wall and to the second side wall and disposed on a first one of the opposite ends of the enclosed space to form a closed end. The first side wall and the second side wall form an open end on a second one of the opposite ends of the enclosed space. The first side wall and the second side wall being tapered such that a perimeter of the closed end is smaller than a perimeter of the open end, and the second side wall of the container contains a lock mechanism.

### BRIEF DESCRIPTION OF THE DRAWINGS

FIG. 1 is a perspective view of one container of a multi-compartment receptacle.

FIG. 2 is another perspective view of one container of a multi-compartment receptacle.

FIG. 3 illustrates two containers locked together to form a multi-compartment waste receptacle.

FIG. 4 illustrates one container stacked inside another container.

FIG. 5 is a top view of two containers of FIGS. 1 and 2 locked together to form a multi-compartment waste receptacle.

FIG. 6 is a bottom view of two containers of FIGS. 1 and 2 locked together to form a multi-compartment waste receptacle.

FIG. 7 is a cross sectional view of two containers having an arc-shaped first side wall and a planar second side wall.

FIG. 8 is a cross-sectional view of two containers each having a first side wall formed as three planar wall portions and a wavy second side wall.

FIG. 9 is a cross-sectional view of two containers each having an arc-shaped first side wall and a second side wall formed with protrusions and indentations connected by segments of perpendicular straight lines.

FIG. 10 is a cross-sectional view of two containers each having an arc-shaped first side wall and a second side wall formed with protrusions and indentations connected by segments of perpendicular straight lines.

FIG. 11 is a cross-sectional view of two containers each having an arc-shaped first side wall and a second side wall formed with protrusions and indentations connected by acute angles.

### DETAILED DESCRIPTION

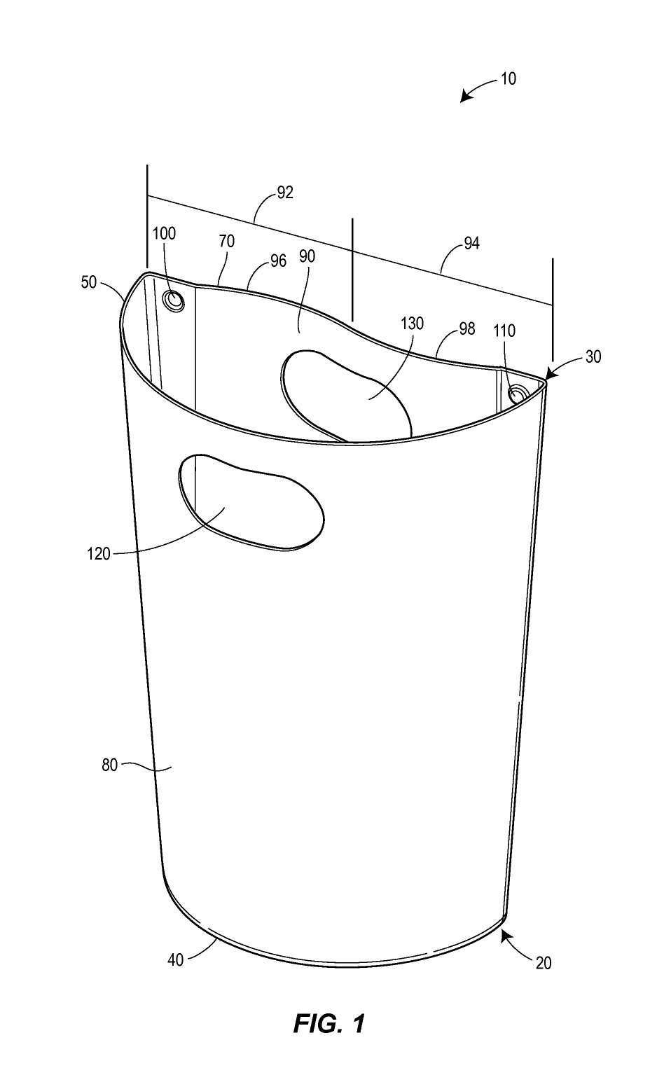

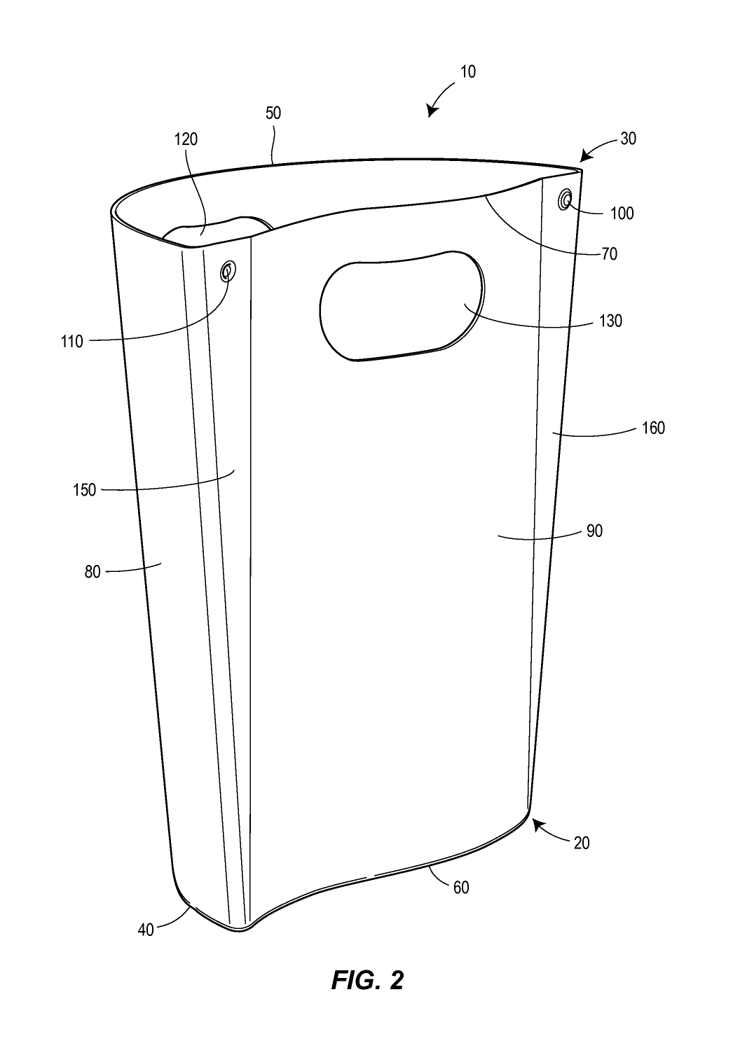

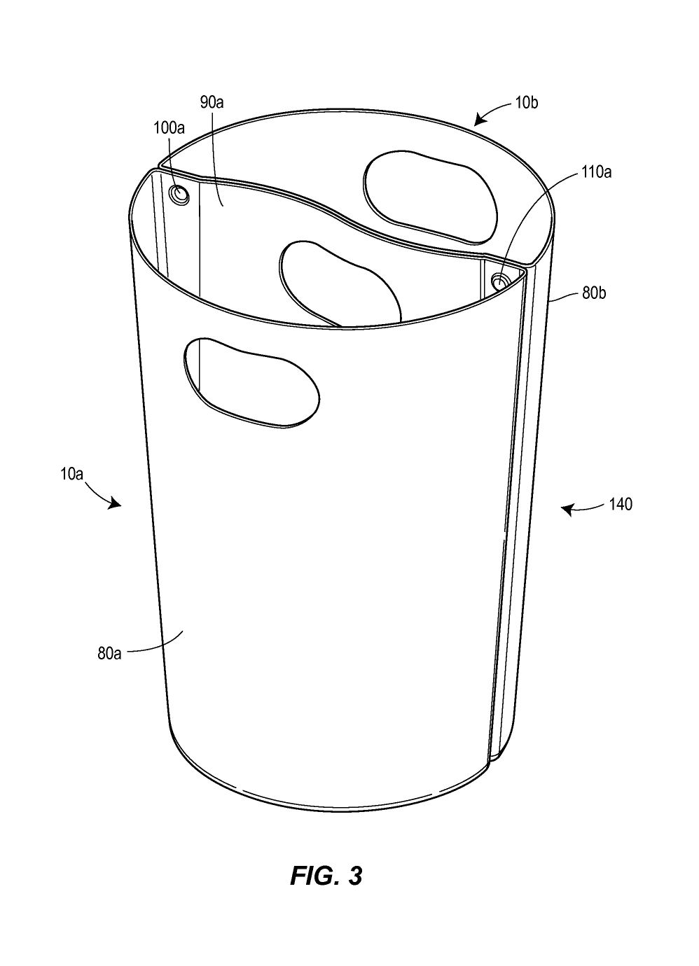

FIGS. 1 and 2 illustrate different views of a single container 10 that consumers may use to store one type of refuse, but which may be combined or configured with additional such containers to produce a multi-compartment receptacle, such as a waste receptacle. Generally, the container shown in FIGS. 1 and 2 is half of the multi-compartment receptacle shown in FIGS. 3, 5, and 6. Alternatively, multiple identical containers as illustrated in and described with respect to FIGS. 1 and 2 may be stacked together as illustrated in FIG. 4.

Returning to FIGS. 1 and 2, the container 10 has a first side 80, a second side 90, and a first or bottom end 20. As illustrated in FIGS. 1 and 2, the first side 80 is rounded or formed as an arc or portion of a circle or oval, for example, and combines with a second side 90 to form the walls of the container 10 while the first end 20 forms a base for the container 10 to keep the container 10 upright. As illustrated in FIGS. 1 and 2, the second side 90 may be wavy or formed as a multi-segmented curve, for example. Of course, the second side 90 may be formed using other shapes (including as a straight wall, triangular shaped, square shaped, etc. protrusions and indentations, or other types of forms) so long as the second side is inversely symmetrical about a center line drawn from the first end 20 to the second end 30, which forms an open top of the container 10. Consumers may dispose of refuse in the space formed inside or bounded by the sides or ends 80, 90 and 20 of the container 10.

As illustrated, a hole in the rounded first side 80 forms a first handle 120, such that the first handle 120 is closer to the open top second end 30 than the base first end 20. A hole in the wavy second side 90 forms a second handle 130, such that the second handle 130 is closer to the open top second end 30 than the base first end 20.

Also as illustrated, the wavy second side 90 has a first portion 92 and a second portion 94, wherein the first portion 92 contains a first panel 160, a male annular lock 100, and an arch 96 and the second portion 94 contains a second panel 150, a female annular lock 110 and an inverted arch 98. A middle panel contains an arch 96 and an inverted arch 98. The first portion 92 and the second portion 94 are congruent and combine such that the arch 96 of the first portion 92 and the inverted arch 98 of the second portion 94 form a sine wave-like shape with the first panel 160 and the second panel 150 at opposite ends of the sine wave-like shape with the male annular lock 100 within the first panel 160 and the female annular lock 110 within the second panel 150 such that the lock 100 and panel 160 are at opposite ends of the second side 90 than the lock 110 and the panel 150.

As illustrated, the panel sections 160 and 150 taper from the open second end 30 to the base first end 20 to enhance the stability of the container 10 and to enhance the effectiveness of the annular locks 100 and 110 when engaged as shown in FIG. 3.

In addition, the position of the locks 100 and 110 in relation to the open second end 30 permits the user space to fold over the top of a garbage bag that lines the container to aid the consumer in emptying the contents of the container.

In addition, as illustrated in FIGS. 1 and 2, the perimeter of the container 10 at the base first end 20, formed by a first edge 40 and a first diameter edge 60, is smaller than the perimeter of the container 10 at the open second end 30, formed by the second edge 50 and the second diameter edge 70. A taper from the open second end 30 to the base first end 20 permits the container 10 to stack inside other identical containers 10.

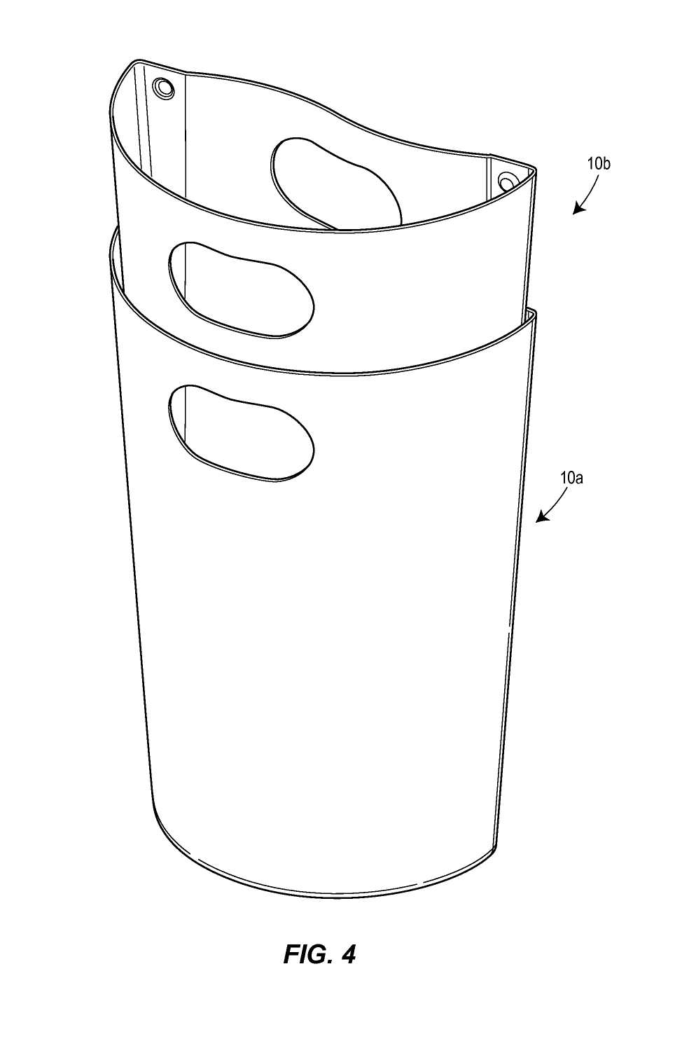

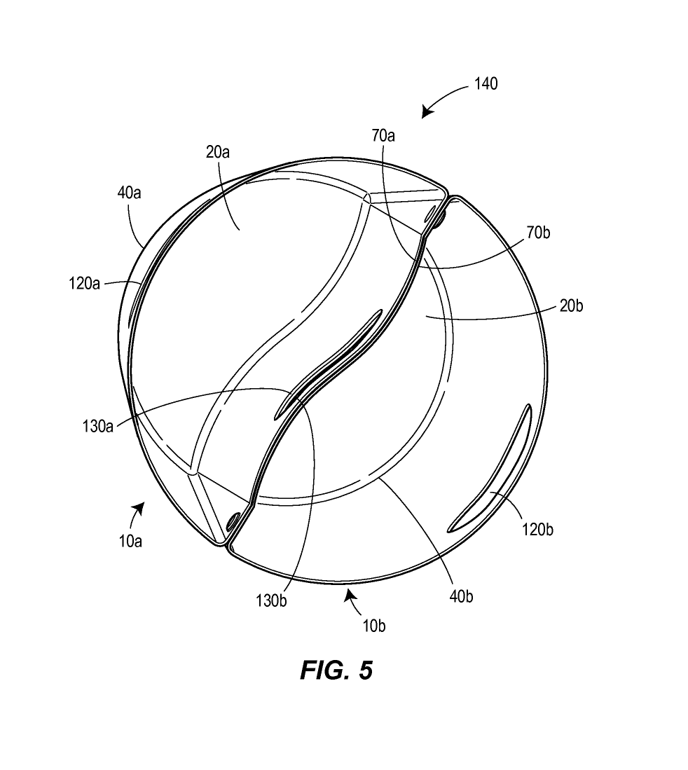

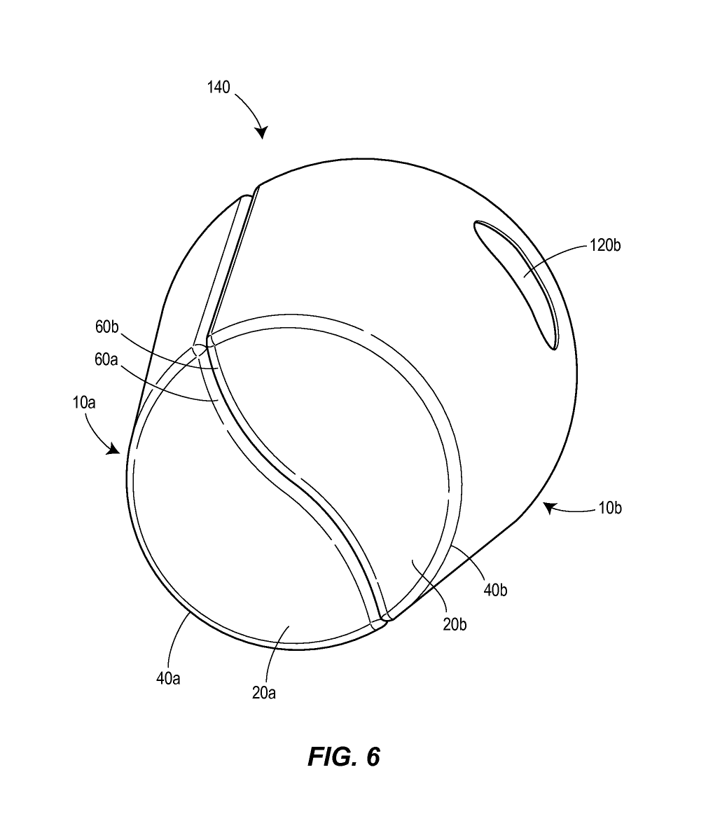

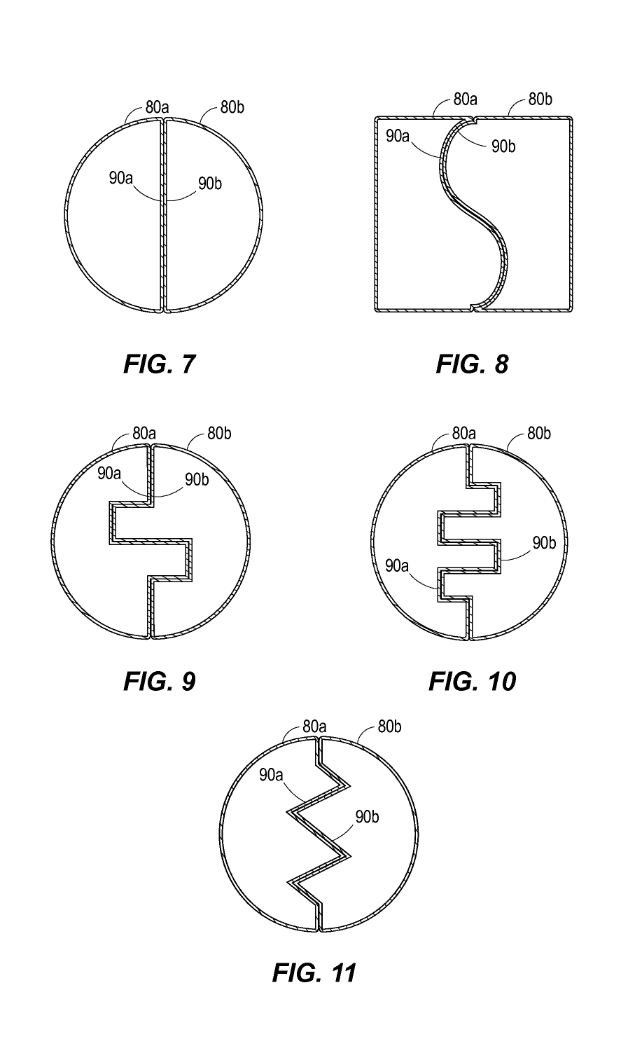

FIG. 3 illustrates two identical containers (labeled as 10a and 10b), as described in FIGS. 1 and 2, locked together to form the multi-compartment receptacle 140. FIGS. 5 and 6 illustrate a top and bottom view, respectively, of a multi-compartment receptacle 140 configured as illustrated in FIG. 3. As illustrated, the two identical containers 10a and 10b of FIG. 3 are locked together using male annular locks 100a and 100b engaged with female annular locks 110a and 110b to form a single waste receptacle having two separate spaces for consumers to separate recyclables from non-recyclables, and to provide several handles for consumers to use to lift the multi-compartment receptacle.

As illustrated in FIGS. 3, 5, and 6, the locks 100a, 100b, 110a, and 110b connect a first container 10a to a second container 10b. For example, the male annular lock 100a of the first container 10a engages the female annular lock 110b of the second container 10b. Similarly, the male annular lock 100b of the second container 10b engages the female annular lock 110a of the first container 10a. When both locks are engaged, the wavy second side 90a of the first container 10a is adjacent to and forms to the wavy second side 90b of the second container 10b, thus providing each container additional support. The inversely symmetrical shape of the wavy second side 90 of each container 10a and 10b permits the containers 10a and 10b to fit adjacent other identical containers, as illustrated in FIGS. 3, 5, and 6. A benefit to using a non-straight side (for example a wavy side) is that when two containers are locked together the adjacent sides of two non-straight sides have more friction than straight sides that helps prevent the two containers from shifting side to side in relation to each other, thus further strengthening the multi-compartment receptacle as a whole.

In addition, the handles 130a and 130b of each adjacent side 90a and 90b, respectively, combine to provide the consumer with the option of using one hand to pick up both containers 10a and 10b of the multi-compartment receptacle 140 at the same time. The consumer, however, may choose to use two hands and use the handles 120a and 120b instead.

Another benefit to using two identical containers to form the multi-compartment receptacle 140 is that manufacturers can reduce costs by using the same processes, configurations, machines, and materials repeatedly for all containers instead of needing separate or different processes, configurations, machines, or materials for each component. In addition, the containers can be made from any number of materials including, for example, polypropylene.

Another benefit of the structure of the container 10 is that it can be made using a single continuous material, for example, it can be made using a standard injection molding process.

Another benefit of the multi-compartment receptacle 140 is that the containers 10a and 10b can be made in one or more different colors. Consumers then have the ability to mix and match the colors he or she prefers. In addition, the container may be made with the rounded first side 80 with one color and the wavy second side 90 in a second color, for example a consumer may choose a neutral or transparent color for the wavy second side 90 so that when the containers lock together to form the multi-compartment receptacle 140 the area where the containers lock together blends together with the color of the recyclable or non-recyclable products contained therein.

Another benefit of the multi-compartment receptacle 140 is that the consumer may use a separate garbage bag in each container 10a and 10b and fold back the edges of each bag over container, and then, when the containers 10a and 10b are locked as shown in FIGS. 3, 4, and 5, the edges of the bags are pinched between the containers 10a and 10b, thus holding the bags firmly in place.

FIG. 4 is a diagram of a first container 10a and a second container 10b stacked together with the second container 10b in the interior of the first container 10a. As illustrated in FIG. 4, the taper of the container from the open second end 30 to the base first end 20 permits the container 10 to stack inside other identical containers 10. In addition, position of the male annular lock 100 prevents container 10b from sliding too far down into container 10a and thus makes the separation of the two containers easier.

FIG. 4 illustrates two containers stacked together; however, more than two containers could be stacked together as well. The ability of the containers to stack is a benefit to manufacturers, retailers, and consumers alike because stacked containers require less storage room than unstacked containers and therefore cost less to store, ship, and display.

While a multi-compartment waste receptacle has been described herein with reference to specific examples, which are intended to be illustrative only and not to be limiting of the disclosure, it will be apparent to those of ordinary skill in the art that changes, additions, or deletions may be made to the disclosed embodiments without departing from the spirit and scope of the disclosure. For example, a hook and eye or other locking mechanisms may be used instead of annular locks, and metal, wood, or other materials may be used instead of polypropylene.

We claim:

1. A container for use as a waste receptacle, comprising:
a first side wall;
a second side wall cooperating with the first side wall to form an enclosed space having two opposite ends; and
an end wall connected to the first side wall and to the second side wall and disposed on a first one of the opposite ends of the enclosed space to form a closed end;
wherein the first side wall and the second side wall form an open end on a second one of the opposite ends of the enclosed space;
the first side wall and the second side wall being tapered such that a perimeter of the closed end is smaller than a perimeter of the open end, and the second side wall of the container being inversely symmetrical about a center line through the second side wall that extends from the open end to the closed end; and
the first side wall meets the second side wall at the edges of the second wall which edges lie in a plane that also goes through the center line of the second wall.

2. The container of claim 1, further comprising a lock mechanism connected to the second side wall.

3. The container of claim 2, wherein the lock mechanism contains a female lock member and a male lock member.

4. The container of claim 3, wherein the male lock member contains a protrusion and the female lock member contains an indentation such that the protrusion is the size of the space created within the indentation.

5. The container of claim 4, wherein the male lock member and the female lock member are annular.

6. The container of claim 4, wherein the male lock member and the female lock member are oblong.

7. The container of claim 1, wherein the second side wall has a first panel, a second panel, and a middle panel.

8. The container of claim 7, wherein the middle panel is planar.

9. The container of claim 7, wherein the first panel and the second panel are planar and the middle panel is wavy.

10. The container of claim 7, wherein the middle panel is formed with protrusions and indentations connected by acute angles.

11. The container of claim 7, wherein the middle panel is formed with protrusions and indentations connected by segments of perpendicular straight lines.

12. The container of claim 7, wherein the first panel and the second panel taper from the open end to the closed end.

13. The container of claim 7, further comprising a lock mechanism connected to the second side wall.

14. The container of claim 13, wherein the lock mechanism contains a female lock member disposed in the first panel and a male lock member disposed in the second panel.

15. The container of claim 1, wherein the first side wall contains a first hole and the second side wall contains a second hole.

16. A container for use as a waste receptacle, comprising:
a first side wall;
a second side wall cooperating with the first side wall to form an enclosed space having two opposite ends; and
an end wall connected to the first side wall and to the second side wall and disposed on a first one of the opposite ends of the enclosed space to form a closed end;
wherein the first side wall and the second side wall form an open end on a second one of the opposite ends of the enclosed space;
the first side wall and the second side wall being tapered such that a perimeter of the closed end is smaller than a perimeter of the open end, and the second side wall of the container contains a lock mechanism.

17. The container of claim 16, wherein the lock mechanism contains a female lock member and a male lock member.

18. The container of claim 17, wherein the male lock member contains a protrusion and the female lock member contains an indentation such that the protrusion is the size of the space created within the indentation.

19. The container of claim 18, wherein the male lock member and the female lock member are each disposed at the same distance from the open end and the female lock member is at the same distance relative to the first edge of the first side wall as the male lock member distance from the second edge of the first side wall.

20. The container of claim 16, wherein the first side wall contains a first hole and the second side wall contains a second hole.
